(19) United States
(12) Patent Application Publication
(10) Pub. No.: US 2026/0341805 A1
(43) Pub. Date: Oct. 29, 2026

(54) POUROUS CARBON-BASED MATERIAL FOR LEAD-ACID BATTERY

(71) Applicants: Arash Ghazitabar, Tehran (IR); Malek Naderi, Tehran (IR); Sina Jorjani, Tehran (IR); Platin Iran Company, Tehran (IR); Institute for Color Science and Technology, Tehran (IR); Amirkabir University of Technology, Tehran (IR)

(72) Inventors: Arash Ghazitabar, Tehran (IR); Malek Naderi, Tehran (IR)

(73) Assignees: Arash Ghazitabar, Tehran (IR); Malek Naderi, Tehran (IR); Sina Jorjani, Tehran (IR); Platin Iran Company, Tehran (IR); Institute for Color Science and Technology, Tehran (IR); Amirkabir University of Technology, Tehran (IR)

(21) Appl. No.: 19/703,093

(22) Filed: Jun. 10, 2026

Related U.S. Application Data
(63) Continuation-in-part of application No. PCT/IB2024/062059, filed on Nov. 30, 2024.

(30) Foreign Application Priority Data
Dec. 10, 2023 (IR) 14025014000300631

(51) Int. Cl. H01M 10/42; H01M 4/02; H01M 4/66; H01M 4/68; H01M 10/06

(52) U.S. Cl. CPC H01M 10/4235; H01M 4/663; H01M 4/68; H01M 10/06; H01M 2004/021

(57) ABSTRACT

Disclosed herein is a lead-acid battery exhibiting high lifespan and electrochemical performance. The lead-acid battery includes a negative electrode and a positive electrode, each including two or more plates covered by a battery paste containing a porous carbon-based material in an amount ranging from about 0.1 wt % to about 1.0 wt %. The porous carbon-based material includes a plurality of porous carbon-based sheets, a plurality of at least one metal ion, and a plurality of at least one heteroatom. The plurality of the at least one metal ion are dispersed between the plurality of porous carbon-based sheets such that the plurality of porous carbon-based sheets are cross-linked via the plurality of the at least one metal ion. The porous carbon-based sheets are further doped with the one or more heteroatoms.

### CROSS REFERENCE TO RELATED APPLICATIONS

This application is a Bypass Application to PCT Application No. PCT/IB2024/062059 filed on Nov. 30, 2024, which is incorporated herein by reference in its entirety

### TECHNICAL FIELD

The present disclosure generally relates to porous carbon-based materials for use in electrodes of lead-acid batteries, and particularly to a graphene aerogel comprising one or more metal ions and one or more heteroatoms for use in positive and/or negative electrodes of lead-acid batteries.

### BACKGROUND

Lead-acid batteries remain among the most widely used electrochemical energy storage systems due to their low cost, high safety, reliability, and high recyclability. Despite the emergence of advanced battery technologies such as lithium-ion and nickel-metal hydride batteries, lead-acid batteries continue to occupy a significant share of the global energy storage market in automotive, industrial, and backup power applications.

One of the major limitations of conventional lead-acid batteries is their relatively short cycle life, particularly under high-rate charge-discharge conditions. The degradation of battery performance is commonly associated with severe sulfation of the electrodes, especially the negative electrode, release of hydrogen gas at the negative electrode, corrosion of the positive electrode, and increasing of oxygen release at the positive electrode. These phenomena may reduce charge acceptance, decrease battery capacity, and shorten service life.

Therefore, there is a need in the art for improved electrode materials and structures capable of mitigating sulfation, reducing gas evolution, suppressing electrode degradation, and enhancing the cycle life and electrochemical performance of lead-acid batteries.

### SUMMARY

This summary is intended to provide an overview of the subject matter of the present disclosure, and is not intended to identify essential elements or key elements of the subject matter, nor is it intended to be used to determine the scope of the claimed implementations. The proper scope of the present disclosure may be ascertained from the claims set forth below in view of the detailed description below and the drawings.

In one general aspect, the present disclosure describes a lead-acid battery. In an exemplary embodiment, the lead-acid battery may include a negative electrode, a positive electrode, and an electrolyte. In an exemplary embodiment, the negative electrode may include at least three plates. In an exemplary embodiment, each plate of the at least three plates of the negative electrode may be covered by a first battery paste. In an exemplary embodiment, the first battery paste may include a lead-based paste and a first porous carbon-based material. In an exemplary embodiment, the first porous carbon-based material may be present in the first battery paste with an amount in a range of about 0.1 wt % to about 0.5 wt % based on a total weight of the first battery paste.

In an exemplary embodiment, the positive electrode may include at least two plates. In an exemplary embodiment, each plate of the at least two plates of the positive electrode may be covered by a second battery paste. In an exemplary embodiment, the second battery paste may include a lead-based paste and a second porous carbon-based material. In an exemplary embodiment, an amount of the second porous carbon-based material in the second battery paste may be less than about 1 wt %. In an exemplary embodiment, the second porous carbon-based material may be present in the second battery paste with an amount in a range of about 0.1 wt % to about 0.5 wt % based on a total weight of the second battery paste. In an exemplary embodiment, the electrolyte may be in physical contact with the negative electrode and the positive electrode.

In an exemplary embodiment, each of the first porous carbon-based material and the second porous carbon-based material may include a plurality of porous carbon-based sheets, a plurality of at least one metal ion, and a plurality of at least one heteroatom. In an exemplary embodiment, the plurality of at least one metal ion may be distributed between the plurality of porous carbon-based sheets and the plurality of porous carbon-based sheets may be cross-linked together via the plurality of the at least one metal ion. In an exemplary embodiment, the plurality of porous carbon-based sheets may be doped with the plurality of the at least one heteroatom.

In an exemplary embodiment, the plurality of porous carbon-based sheets may include at least one of graphene, graphene aerogel, graphene oxide, reduced graphene oxide, three-dimensional graphene, graphene oxide aerogel, aerographene, and combinations thereof. In an exemplary embodiment, an average pore size of the plurality of porous carbon-based sheets of the first porous carbon-based material may be within a range of about 25 nm to about 50 nm. In an exemplary embodiment, an average pore size of the plurality of porous carbon-based sheets of the second porous carbon-based material may be within a range of about 5 nm to about 20 nm.

In an exemplary embodiment, the at least one metal ion may include at least one of a transition metal ion, an alkaline earth metal ion, and combinations thereof. In an exemplary embodiment, an amount of the plurality of the at least one metal ion may be in a range of about 0.1 wt % to about 5 wt % based on a total weight of each of the first porous carbon-based material and the second porous carbon-based material.

In an exemplary embodiment, the at least one metal ion of the first porous carbon-based material may include at least one of zinc, copper, nickel, cobalt, and combinations thereof. In an exemplary embodiment, an amount of copper may be in a range of about 0.2 wt % to about 1.5 wt % based on a total weight of the first porous carbon-based material. In an exemplary embodiment, an amount of zinc may be in a range of about 0.3 wt % to about 1.6 wt % based on a total weight of the first porous carbon-based material.

In an exemplary embodiment, the at least one metal ion of the second porous carbon-based material may include at least one of zinc ion, magnesium ion, calcium ion, and combinations thereof. In an exemplary embodiment, an amount of magnesium may be in a range of about 0.2 wt % to about 1.0 wt % based on a total weight of the second porous carbon-based material. In an exemplary embodiment, an amount of zinc may be in a range of about 0.3 wt % to about 1.6 wt % based on a total weight of the second porous carbon-based material.

In an exemplary embodiment, an amount of the plurality of the at least one heteroatom may be in a range of about 0.1 wt % to about 2.0 wt % based on a total weight of each of the first porous carbon-based material and the second porous carbon-based material.

In an exemplary embodiment, the plurality of the at least one heteroatom of the first porous carbon-based material may include at least one of nitrogen, sulfur, and combinations thereof. In an exemplary embodiment, an amount of nitrogen may be in a range of about 0.5 wt % to about 2 wt % based on a total weight of the first porous carbon-based material. In an exemplary embodiment, an amount of sulfur may be in a range of about 0.1 wt % to about 1 wt % based on a total weight of the first porous carbon-based material.

In an exemplary embodiment, the plurality of the at least one heteroatom of the second porous carbon-based material may include at least one of nitrogen, boron, phosphorus, sulfur, and combinations thereof. In an exemplary embodiment, the plurality of the at least one heteroatom of the second porous carbon-based material may include a combination of at least two heteroatoms with a weight ratio of a first heteroatom to a second heteroatom in a range of 1:0 to 0:1. In an exemplary embodiment, an amount of nitrogen may be in a range of about 0.1 wt % to about 1.5 wt % based on a total weight of the second porous carbon-based material. In an exemplary embodiment, an amount of each heteroatom of boron, phosphorus, or sulfur may be in a range of about 0.1 wt % to about 1 wt % based on a total weight of the second porous carbon-based material.

Other exemplary systems, methods, features and advantages of the implementations will be, or will become, apparent to one of ordinary skill in the art upon examination of the following figures and detailed description. It is intended that all such additional systems, methods, features and advantages be included within this description and this summary, be within the scope of the implementations, and be protected by the claims herein.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 illustrates a plot of X-ray diffraction (XRD) pattern analysis of an exemplary graphene oxide (graph a), an exemplary produced porous carbon-based material for an exemplary negative electrode of an exemplary lead-acid battery (graph b), and an exemplary produced porous carbon-based material for an exemplary positive electrode of an exemplary lead-acid battery (graph c), consistent with one or more exemplary embodiments of the present disclosure.

FIG. 2 illustrates a plot of Fourier-transform infrared spectroscopy (FTIR) spectra of an exemplary graphene aerogel (spectrum a), an exemplary porous carbon-based material for an exemplary negative electrode of an exemplary lead-acid battery (spectrum b), and an exemplary porous carbon-based material for an exemplary positive electrode of an exemplary lead-acid battery (spectrum c), consistent with one or more exemplary embodiments of the present disclosure.

FIG. 3 illustrates a Brunauer-Emmett-Teller (BET) plot of N₂-adsorption/desorption on an exemplary porous carbon-based material for an exemplary negative electrode of an exemplary lead-acid battery (graph a) and an exemplary porous carbon-based material for an exemplary positive electrode construction of an exemplary lead-acid battery (graph b), consistent with one or more exemplary embodiments of the present disclosure.

FIG. 4 illustrates a Barrett-Joyner-Halenda (BJH) plot of N₂-adsorption/desorption on an exemplary porous carbon-based material for an exemplary negative electrode of an exemplary lead-acid battery (graph a) and an exemplary porous carbon-based material for an exemplary positive electrode of an exemplary lead-acid battery (graph b), consistent with one or more exemplary embodiments of the present disclosure.

FIGS. 5A-5B illustrate scanning electron microscopy (SEM) images of an exemplary produced porous carbon-based material for an exemplary positive electrode of an exemplary lead-acid battery (FIG. 5A) and an exemplary produced porous carbon-based material for an exemplary negative electrode of an exemplary lead-acid battery (FIG. 5B), consistent with one or more exemplary embodiments of the present disclosure.

FIG. 6 illustrates a plot of cut-off voltages verses cycle number for an exemplary common lead-acid battery (graph a), an exemplary lead-acid battery including an exemplary produced negative electrode (graph b), an exemplary lead-acid battery including an exemplary positive electrode (graph c), an exemplary produced lead-acid battery including an exemplary produced negative electrode containing 0.1 wt % of exemplary produced porous carbon-based material for an exemplary negative electrode and an exemplary produced positive electrode containing 0.1 wt % of an exemplary produced porous carbon-based material for an exemplary positive electrode (graph d), and an exemplary produced lead-acid battery including an exemplary produced negative electrode containing 0.2 wt % of an exemplary produced porous carbon-based material for an exemplary negative electrode and an exemplary produced positive electrode containing 0.1 wt % of an exemplary produced porous carbon-based material for an exemplary positive electrode (graph e), consistent with one or more exemplary embodiments of the present disclosure.

FIG. 7 illustrates a cyclic voltammogram of an exemplary negative electrode of an exemplary lead-acid battery without an exemplary produced porous carbon-based material (graph a) and including an exemplary produced porous carbon-based material for negative electrode (graph b), consistent with one or more exemplary embodiments of the present disclosure.

FIG. 8 illustrates a current-potential (I-V) curve of an exemplary positive electrode without an exemplary produced porous carbon-based material (graph a), and an exemplary positive electrode including 0.1 wt % of exemplary porous carbon-based material for negative electrode construction (graph b), including 0.1 wt % of exemplary porous carbon-based material for positive electrode construction (graph c), and including 0.2 wt % of exemplary porous carbon-based material for positive electrode construction (graph d), consistent with one or more exemplary embodiments of the present disclosure.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

The following detailed description is presented to enable a person skilled in the art to make and use the methods and devices disclosed in exemplary embodiments of the present disclosure. For purposes of explanation, specific nomenclature is set forth to provide a thorough understanding of the present disclosure. However, it will be apparent to one skilled in the art that these specific details are not required to practice the disclosed exemplary embodiments. Descriptions of specific exemplary embodiments are provided only as representative examples. Various modifications to the exemplary implementations will be readily apparent to one skilled in the art, and the general principles defined herein may be applied to other implementations and applications without departing from the scope of the present disclosure. The present disclosure is not intended to be limited to the implementations shown, but is to be accorded the widest possible scope consistent with the principles and features disclosed herein.

Herein, a porous carbon-based material is disclosed for use in positive and/or negative electrodes of a lead-acid battery. In an exemplary embodiment, an exemplary porous carbon-based material may include a plurality of porous carbon-based sheets coupled with one or more metal ions and one or more heteroatoms, thereby overcoming limitations associated with conventional electrode materials and improving lifespan and electrochemical performance of an exemplary lead-acid battery. In an exemplary embodiment, a composition and structure of an exemplary porous carbon-based material may be tailored according to the requirements of a particular electrode, such that a first porous carbon-based material may be produced for a negative electrode and a second porous carbon-based material may be produced for a positive electrode.

In an exemplary embodiment, an exemplary lead-acid battery is disclosed. In an exemplary embodiment, an exemplary lead-acid battery may include a negative electrode, a positive electrode, and an electrolyte. In an exemplary embodiment, an exemplary negative electrode may include at least three plates. In an exemplary embodiment, each plate of an exemplary at least three plates of an exemplary negative electrode may be covered by a first battery paste. In an exemplary embodiment, an exemplary first battery paste may include a lead-based paste and a first porous carbon-based material. In an exemplary embodiment, an exemplary first porous carbon-based material may be mixed with an exemplary lead-based paste, thereby forming an exemplary first battery paste. In an exemplary embodiment, an amount of an exemplary first porous carbon-based material in an exemplary first battery paste may be less than about 1 wt %. In an exemplary embodiment, an exemplary first porous carbon-based material may be present in an exemplary first battery paste with an amount in a range of about 0.1 wt % to about 0.5 wt % based on a total weight of an exemplary first battery paste.

In an exemplary embodiment, an exemplary positive electrode may include at least two plates. In an exemplary embodiment, each plate of an exemplary at least two plates of an exemplary positive electrode may be covered by a second battery paste. In an exemplary embodiment, an exemplary second battery paste may include a lead-based paste and a second porous carbon-based material. In an exemplary embodiment, an exemplary second porous carbon-based material may be mixed with an exemplary lead-based paste, thereby forming an exemplary second battery paste. In an exemplary embodiment, an amount of an exemplary second porous carbon-based material in an exemplary second battery paste may be less than about 1 wt %. In an exemplary embodiment, an exemplary second porous carbon-based material may be present in an exemplary second battery paste with an amount in a range of about 0.1 wt % to about 0.5 wt % based on a total weight of an exemplary second battery paste. In an exemplary embodiment, an exemplary lead-based paste used in either an exemplary first battery paste or an exemplary second battery paste may include at least one of a lead paste, a lead oxide paste, and combinations thereof. In an exemplary embodiment, an exemplary lead-based paste used in either an exemplary first battery paste or an exemplary second battery paste may include a mixture of lead oxide, sulfuric acid, and water. In an exemplary embodiment, a weight percent of sulfuric acid and water may be different in an exemplary lead-based paste in an exemplary first battery paste and an exemplary second battery paste.

In an exemplary embodiment, an exemplary electrolyte may be in physical contact with an exemplary negative electrode and an exemplary positive electrode. In an exemplary embodiment, an exemplary electrolyte may include sulfuric acid. In an exemplary embodiment, an exemplary electrolyte may include sulfuric acid with a density of about 1.28 gr/cm³.

In an exemplary embodiment, an exemplary lead-acid battery may further include an AGM separator positioned between an exemplary negative electrode and an exemplary positive electrode. In an exemplary embodiment, an exemplary AGM separator may prevent contact between an exemplary negative electrode and an exemplary positive electrode, thereby preventing internal short circuits within inside an exemplary lead-acid battery. In an exemplary embodiment, an exemplary negative electrode and an exemplary positive electrode may be welded together and inserted into a battery case made of flame-retardant ABS polymer. In an exemplary embodiment, an exemplary lead-acid battery may then undergo an initial charging process prior to operation.

In an exemplary embodiment, each exemplary porous carbon-based material of an exemplary first porous carbon-based material and an exemplary second porous carbon-based material may include a plurality of porous carbon-based sheets, a plurality of at least one metal ion, and a plurality of at least one heteroatom. In an exemplary embodiment, an exemplary plurality of at least one metal ion may be distributed between an exemplary plurality of porous carbon-based sheets. In an exemplary embodiment, an exemplary plurality of porous carbon-based sheets may be cross-linked together via an exemplary plurality of at least one metal ion. In an exemplary embodiment, an exemplary plurality of porous carbon-based sheets may be doped with an exemplary plurality of at least one heteroatom.

As used herein, “porous carbon-based sheets” may refer to a three-dimensional porous network structure including carbon atoms or carbon atoms. In some embodiments, an exemplary three-dimensional porous network structure may further include oxygen-containing functionalities attached along a plurality of edges and basal planes of an exemplary three-dimensional porous network structure. In an exemplary embodiment, an exemplary plurality of porous carbon-based sheets along with different ions and heteroatoms including an exemplary plurality of at least one metal ion and an exemplary plurality of at least one heteroatom may contribute to reducing sulfation, corrosion, and gas evolution phenomena associated with lead-acid batteries, thereby improving battery performance and cycle life.

In an exemplary embodiment, an exemplary plurality of porous carbon-based sheets may include at least one of graphene, graphene aerogel, graphene oxide, reduced graphene oxide, three-dimensional graphene, graphene oxide aerogel, aerographene, and combinations thereof. In an exemplary embodiment, an exemplary plurality of porous carbon-based sheets of an exemplary first porous carbon-based material may have an average pore size within a range of about 25 nm to about 50 nm. In an exemplary embodiment, an exemplary plurality of porous carbon-based sheets of an exemplary second porous carbon-based material may may have an average pore size within a range of about 5 nm to about 20 nm.

In an exemplary embodiment, an exemplary at least one metal ion may include at least one of a transition metal ion, an alkaline earth metal ion, and combinations thereof. In an exemplary embodiment, an amount of an exemplary plurality of the at least one metal ion may be in a range of about 0.1 wt % to about 5 wt % based on a total weight of each porous carbon-based material of an exemplary first porous carbon-based material and an exemplary second porous carbon-based material. In an exemplary embodiment, an amount of an exemplary plurality of the at least one metal ion may be in a range of about 0.2 wt % to about 1.5 wt % based on a total weight of each porous carbon-based material of an exemplary first porous carbon-based material and an exemplary second porous carbon-based material. In an exemplary embodiment, an exemplary plurality of at least one metal ion may be distributed between an exemplary plurality of porous carbon-based sheets, thereby enhancing a transfer of an exemplary electrolyte and/or an electrical charge among an exemplary plurality of porous carbon-based sheets and preventing a stacking of an exemplary plurality of porous carbon-based sheets to each other.

In an exemplary embodiment, an exemplary at least one metal ion of an exemplary first porous carbon-based material may include at least one of zinc, copper, nickel, cobalt, and combinations thereof. In an exemplary embodiment, an amount of copper may be in a range of about 0.2 wt % to about 1.5 wt % based on a total weight of an exemplary first porous carbon-based material. In an exemplary embodiment, an amount of zinc may be in a range of about 0.3 wt % to about 1.6 wt % based on a total weight of an exemplary first porous carbon-based material.

In an exemplary embodiment, an exemplary combination of at least two transition metal ions may include a combination of copper and zinc ions. In such embodiments, exemplary copper and zinc ions may be mounted between an exemplary plurality of porous carbon-based sheets. In an exemplary embodiment, exemplary copper and zinc ions may be cross-linked to surface of an exemplary plurality of porous carbon-based sheets.

In an exemplary embodiment, an exemplary at least one metal ion of an exemplary second porous carbon-based material may include at least one of zinc ion, magnesium ion, calcium ion, and combinations thereof. In an exemplary embodiment, an amount of magnesium may be in a range of 0.2 wt % to about 1 wt % based on a total weight of an exemplary second porous carbon-based material. In an exemplary embodiment, an amount of zinc may be in a range of about 0.3 wt % to about 1.6 wt % based on a total weight of an exemplary second porous carbon-based material.

In an exemplary embodiment, a water-soluble salt of an exemplary transition metal, an exemplary alkaline earth metal, and/or an exemplary combination of thereof may be used to provide an exemplary at least one metal ion. As used herein, an exemplary “water-soluble salt” may refer to an ionic compound that readily dissolves in water and dissociates into ions in an aqueous solution. In an exemplary embodiment, an exemplary water-soluble salt may include at least one of a sulfate salt, a nitrate salt, a phosphate salt, a chloride salt, an acetate salt, and combinations thereof.

In an exemplary embodiment, an exemplary at least one metal ion metal ion may include a combination of an exemplary transition metal ion and an exemplary alkaline earth metal ion. In an exemplary embodiment, an exemplary at least one metal ion may include a combination of zinc and magnesium ions, where exemplary zinc and magnesium ions may be mounted between an exemplary plurality of porous carbon-based sheets, and specifically, cross-linked to an exemplary plurality of porous carbon-based sheets such that exemplary zinc and magnesium ions may be mounted between an exemplary plurality of porous carbon-based sheets.

In an exemplary embodiment, an amount of an exemplary plurality of the at least one heteroatom may be in a range of about 0.1 wt % to about 2.0 wt % based on a total weight of each exemplary porous carbon-based material of an exemplary first porous carbon-based material and an exemplary second porous carbon-based material. In an exemplary embodiment, an amount of an exemplary plurality of the at least one heteroatom may be in a range of about 0.1 wt % to about 0.7 wt % based on a total weight of each exemplary porous carbon-based material of an exemplary first porous carbon-based material and an exemplary second porous carbon-based material.

In an exemplary embodiment, an exemplary plurality of at least one heteroatom of an exemplary first porous carbon-based material may include at least one of nitrogen, sulfur, and combinations thereof. In an exemplary embodiment, an amount of nitrogen may be in a range of about 0.5 wt % to about 2 wt % based on a total weight of an exemplary first porous carbon-based material. In an exemplary embodiment, an amount of nitrogen may be in a range of about 0.7 wt % to about 1.5 wt % based on a total weight of an exemplary first porous carbon-based material. In an exemplary embodiment, an amount of sulfur may be in a range of about 0.1 wt % to about 1 wt % based on a total weight of an exemplary first porous carbon-based material.

In an exemplary embodiment, an exemplary plurality of at least one heteroatom of an exemplary second porous carbon-based material may include at least one of nitrogen, boron, phosphorus, sulfur, and combinations thereof. In an exemplary embodiment, an amount of nitrogen may be in a range of about 0.1 wt % to about 1.5 wt % based on a total weight of an exemplary second porous carbon-based material. In an exemplary embodiment, an amount of nitrogen may be in a range of about 0.4 wt % to about 1.0 wt % based on a total weight of an exemplary second porous carbon-based material. In an exemplary embodiment, an amount of each heteroatom of boron, phosphorus, or sulfur may be in a range of about 0.1 wt % to about 1.0 wt % based on a total weight of an exemplary second porous carbon-based material. In an exemplary embodiment, an amount of each heteroatom of boron, phosphorus, or sulfur may be in a range of about 0.2 wt % to about 0.5 wt % based on a total weight of an exemplary second porous carbon-based material.

In an exemplary embodiment, an exemplary plurality of at least one heteroatom of the second porous carbon-based material may include a combination of at least two heteroatoms with a weight ratio of a first heteroatom to a second heteroatom in a range of 1:0 to 0:1. In an exemplary embodiment, an exemplary plurality of at least one heteroatom of the second porous carbon-based material may include a combination of nitrogen and boron with a weight ratio of nitrogen to boron in a range of 1:0 to 0:1. In an exemplary embodiment, such exemplary second porous carbon-based material may further include phosphorus and/or sulfur.

In an exemplary embodiment, a solution of at least one of an ammonia solution, an ethylenediamine (EDA) solution, an ethylenediaminetetraacetic acid (EDTA) solution, a thiourea solution, an ammonium sulfate solution, an ammonium hydroxide solution, a carbamide solution, and combinations thereof may be used to dope nitrogen atoms to an exemplary plurality of porous carbon-based sheets of each of an exemplary first porous carbon-based material or an exemplary second porous carbon-based material. In an exemplary embodiment, a solution of at least one of a hydrogen orthoborate solution, boric acid, a boron trioxide (B₂O₃) solution, a sodium borohydride solution, an ammonia borane solution, and combinations thereof may be used to dope boron atoms to an exemplary plurality of porous carbon-based sheets of an exemplary second porous carbon-based material.

In an exemplary embodiment, a chemical reducing agent may be used to prepare surface of an exemplary plurality of porous carbon-based sheets for doping an exemplary plurality of at least one heteroatom for construction of either an exemplary negative electrode or an exemplary positive electrode. In an exemplary embodiment, an exemplary chemical reducing agent may include at least one of ascorbic acid, sodium sulfide, sodium bisulfite, hydrazine, sodium borohydride, cysteine, and combinations thereof. In an exemplary embodiment, a mass ratio of an exemplary chemical reducing agent to an exemplary plurality of porous carbon-based sheets may be adjusted in a range of 1:10 to 10:1.

### Example 1: Synthesis of Porous Carbon-Based Material for Positive Electrode Construction

In this example, an exemplary porous carbon-based material for an exemplary positive electrode of an exemplary lead-acid battery was synthesized based on one or more exemplary embodiments of the present disclosure. Firstly, a solution of a transition metal salt and an alkaline earth metal salt (including zinc sulfate, magnesium sulfate, and calcium sulfate) with an amount of 10 wt % of the salts was mixed with graphene oxide such that a weight ratio of the solution to graphene was in a range of 1:2 to 2:1 followed by stirring for about 4 hours at a temperature level of about 25 °C and an atmosphere pressure. To obtain a three-dimensional (3D) structured porous carbon-based material, a chemical reducing agent with a mass ratio of 1:1 to 10:1 in respect with graphene was added to the produced graphene cross-linked with combination of the transition and alkaline earth metal ions and stirred for about 15 minutes and then was kept at a temperature level less than 100 °C, for example, 90 °C within a closed container. Afterwards, the produced 3D structured porous carbon-based material was washed three times with distilled water to remove any unreacted materials. Then, the produced 3D structured porous carbon-based material was added to an ammonia and/or ethylenediamine (EDA) solution, specifically ammonia solution with a concentration of 2-10 wt % and an exemplary volume ratio of 1:1 to 1:10, specifically 1:5 in accordance with a volume of 3D structured porous carbon-based material for nitrogen doping. The 3D structured porous carbon-based material was additionally doped by boron using boric acid through a procedure similar to nitrogen doping. Afterwards, obtained mixture of the 3D structured porous carbon-based material cross-linked with the transition and alkaline earth metal ions and doped with nitrogen and boron atoms was heated at a temperature level of 25-95 °C, specifically 60-80 °C for a time duration of 1-24 hours, specifically 4-10 hours. After that, the produced 3D structured porous carbon-based material cross-linked with transition and alkaline earth metal ions and doped with nitrogen and boron atoms was placed in a freezer at a temperature level of −40 °C for a time duration of about 24 hours to completely freeze, followed by freeze-drying at a temperature level of −65 °C within a time period of 48 hours to eliminate residual water without disruption of porous and 3D structure of the produced 3D structured porous carbon-based material cross-linked with the transition and alkaline earth metal ions and doped with nitrogen and boron atoms.

### Example 2: Synthesis of Porous Carbon-Based Material for Negative Electrode Construction

In this example, an exemplary porous carbon-based material for an exemplary negative electrode of an exemplary lead-acid battery was synthesized based on one or more exemplary embodiments of the present disclosure. Firstly, a solution of a combination of two transition metal salts, specifically a solution of zinc sulfate and copper sulfate, was mixed to graphene oxide such that a weight ratio of the solution of zinc sulfate and copper sulfate to graphene was in a range of 1:5 to 5:1, specifically in a range of 1:2 to 2:1, followed by stirring for about 2 hours at a temperature level of about 25 °C and an atmosphere pressure. Consequently, a 3D structured porous carbon-based material was obtained via cross-linking graphene sheets with combination of the two transition metal ions. To obtain a 3D structured porous carbon-based material, a chemical reducing agent, specifically ascorbic acid, with a ratio of 1:1 to 10:1 in respect with graphene was added to the produced graphene cross-linked with the combination of two transition metal ions and stirred for about 15 minutes and then was kept at a temperature level less than 100 °C, specifically about 90 °C in a closed container for about 8 hours. Afterwards, the produced 3D structured porous carbon-based material was washed three times with distilled water to remove any unreacted materials. Following that, the produced 3D structured porous carbon-based material was added to an ammonia and/or ethylenediamine (EDA) solution, specifically, ammonia solution for nitrogen doping with a concentration of ammonia and/or ethylenediamine (EDA) solution in a range of 2-10 wt % and a volume ratio of 1:1 to 1:10, specifically 1:5 in accordance with volume of the produced 3D structured porous carbon-based material. Thereafter, the obtained mixture of the 3D structured porous carbon-based material cross-linked with the two transition metal ions and doped with nitrogen atoms was heated at a temperature level of 25-95 °C, specifically 60-80 °C for a time duration of about 6 hours. After that, the produced 3D structured porous carbon-based material cross-linked with the two transition metal ions and doped with nitrogen atoms was placed in a freezer at a temperature level of about −40 °C for a time duration of 24-48 hours to completely freeze, followed by freeze-drying at a temperature level of about −65 °C for a time duration of about 48 hours to eliminate residual water without disruption of porous and 3D structure of the produced 3D structured porous carbon-based material cross-linked with the two transition metal ions and doped with nitrogen atoms.

### Example 3: Characterization of Porous Carbon-Based Material for Negative and Positive Electrodes Construction

In this example, the produced porous carbon-based materials for positive and negative electrodes constructions in “Example 1” and “Example 2” described hereinabove, were characterized by powder X-ray diffraction (XRD) analysis, Fourier-transform infrared spectroscopy (FTIR) analysis, and scanning electron microscopy (SEM). Average pore radius as well as specific surface area of exemplary produced porous carbon-based material for both exemplary positive and negative electrodes were evaluated using Brunauer-Emmett-Teller (BET) and Barrett-Joyner-Halenda (BJH) analysis.

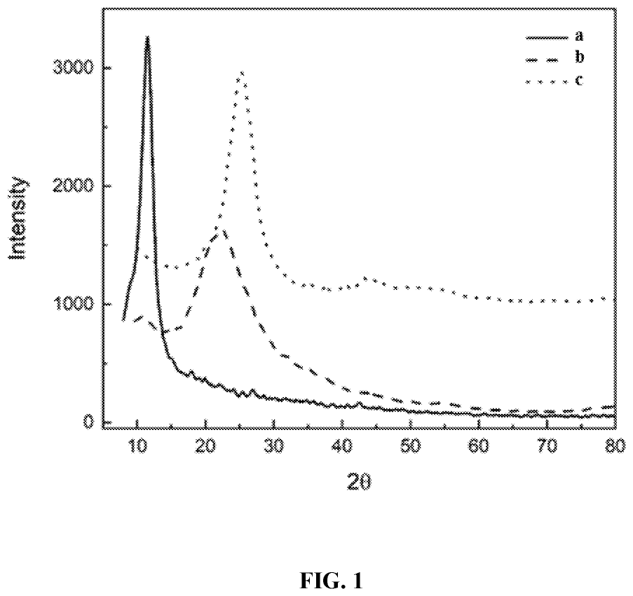

FIG. 1 illustrates a plot of XRD pattern analysis of exemplary graphene oxide (graph a), exemplary produced porous carbon-based material for exemplary negative electrode of an exemplary lead-acid battery (part b), and exemplary produced porous carbon-based material for exemplary positive electrode of an exemplary lead-acid battery (part c), consistent with one or more exemplary embodiments of the present disclosure. As may be seen in FIG. 1, intensity of an exemplary main peak at 26 degrees for exemplary produced porous carbon-based material for positive electrode is higher than exemplary common graphene oxides as well as exemplary produced porous carbon-based material for negative electrode due to doping two different atoms. These exemplary results reveal successful doping of boron atoms alongside nitrogen atoms in exemplary produced porous carbon-based material for positive electrode construction.

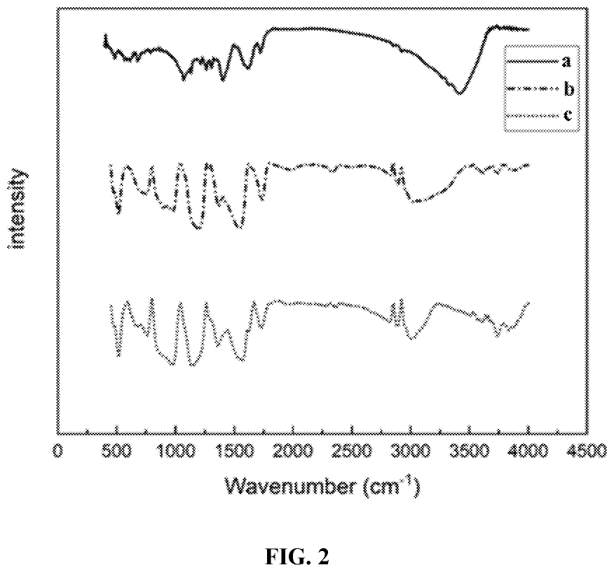

Furthermore, FIG. 2 illustrates a plot of FTIR spectra of exemplary graphene oxide (part a), exemplary porous carbon-based material for an exemplary negative electrode of an exemplary lead-acid battery (part b), and exemplary porous carbon-based material for an exemplary positive electrode of an exemplary lead-acid battery (part c), consistent with one or more exemplary embodiments of the present disclosure. As FTIR spectra illustrated in FIG. 2, a peak of hydroxyl group observed at 3400 cm⁻¹ for exemplary graphene oxide is significantly reduced for both exemplary produced carbon-based materials for exemplary positive and negative electrodes that may be an indicator of a reduction process. Additionally, both exemplary produced porous carbon-base materials for exemplary positive and negative electrodes show higher peak intensities for C—C bonds and these peaks have shifted to shorter wavelengths compared to exemplary graphene oxide, indicating an existence of doped heteroatoms such as nitrogen and boron in exemplary produced carbon-based materials. Moreover, a peak at about 1400 cm⁻¹ may be attributed to nitrogen doping, which is present in both exemplary produced porous carbon-base materials for exemplary positive and negative electrodes. Also, peaks at wavenumber range between 500 cm⁻¹ to 600 cm⁻¹ may be associated with the presence of zinc and copper metal ions incorporated into exemplary produced carbon-based material for exemplary negative electrode.

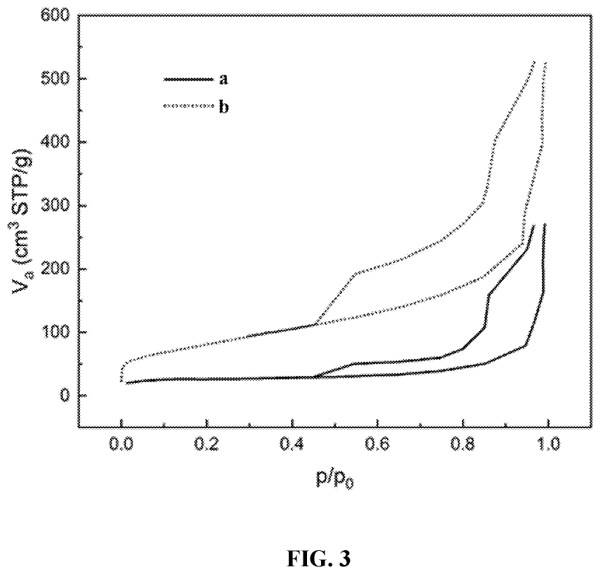

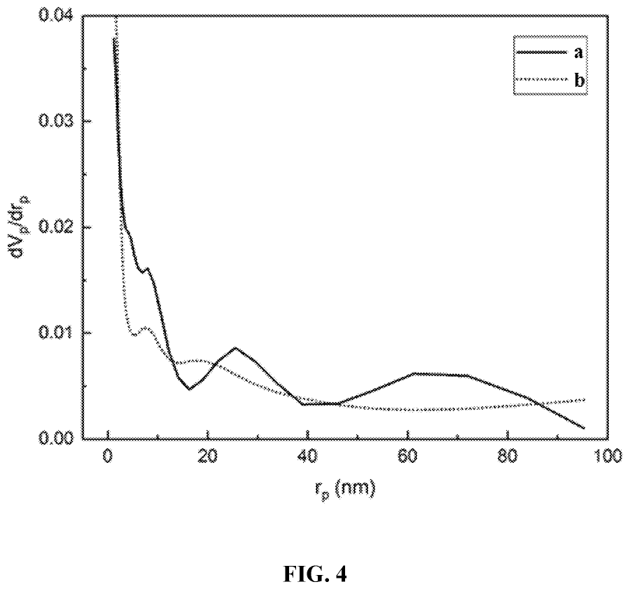

FIG. 3 and FIG. 4 illustrate a BET plot and a BJH plot of N₂-adsorption/Desorption on exemplary porous carbon-based material for exemplary negative electrode (graph a) and exemplary produced porous carbon-based material for exemplary positive electrode (graph b), consistent with one or more exemplary embodiments of the present disclosure. Furthermore, specific surface area, total pore volume and average pore size for both exemplary produced porous carbon-based materials based on BET and BJH analyses are listed in Table 1.

The hysteresis loop observed in the N₂-adsorption/Desorption isotherms serves as an exemplary measure of the mesoporous specific surface area. As may be seen in FIG. 3 and Table 1, exemplary produced porous carbon-based material in “Example 2” for exemplary negative electrode may have a lower specific surface area compared to exemplary produced porous carbon-based material in “Example 1” for exemplary positive electrode. This exemplary result may be attributed to the fact that a higher specific surface area may increase hydrogen gas release reactions.

TABLE 1
Specific surface and average pore size for exemplary
porous carbon-based materials for positive and negative
electrodes using BET and BJH analyses

| | Specific | | |
|---|---|---|---|
| | Surface | Pore Volume | Average Pore |
| Samples | Area (m²g⁻¹) | (cm³g⁻¹) | Size (nm) |
| Porous Carbon-Based | 208.84 | 0.339 | 10.95 |
| Materials for Negative | | | |
| Electrode Construction | | | |
| Porous Carbon-Based | 285.00 | 0.780 | 6.49 |
| Materials for Positive | | | |
| Electrode Construction | | | |

Furthermore, as illustrated in FIG. 4 and Table 1, an exemplary produced porous carbon-material for exemplary negative electrode may exhibit larger pore sizes compared to exemplary produced porous carbon-material for exemplary positive electrode. This exemplary larger pore size may result in a reduction in hydrogen gas release within exemplary negative electrode of an exemplary lead-acid battery, while simultaneously providing an optimal surface for an exemplary electrolyte transport as well as formation of fine lead sulfate crystals. The tuning of exemplary pore size distribution may be achieved through doping different heteroatoms as well as metal ions in each produced porous carbon-material for exemplary negative electrode construction and exemplary positive electrode construction.

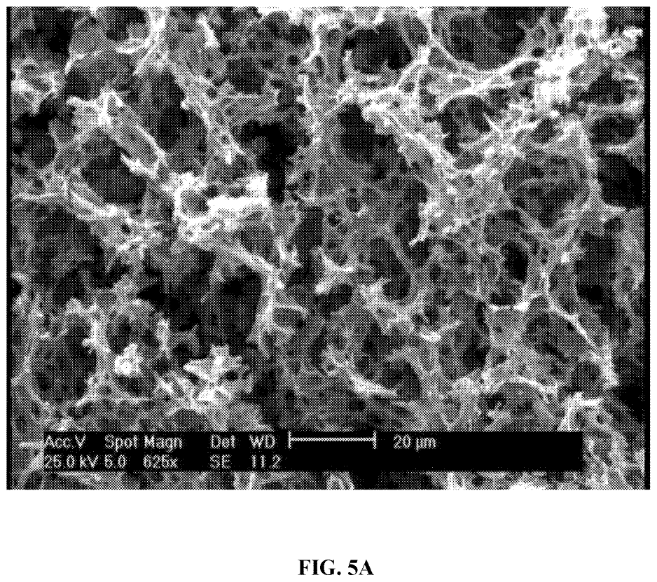

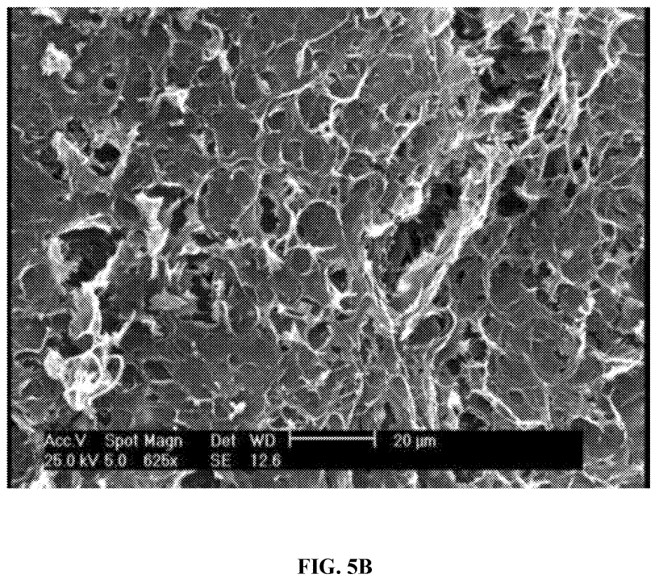

Morphology and pore size of both exemplary produced porous carbon-based material for negative and positive electrodes of an exemplary lead-acid battery were examined using SEM analysis. FIGS. 5A-5B illustrate scanning electron microscopy (SEM) images of an exemplary produced porous carbon-based material for an exemplary positive electrode of an exemplary lead-acid battery (FIG. 5A) and an exemplary produced porous carbon-based material for an exemplary negative electrode of an exemplary lead-acid battery (FIG. 5B), consistent with one or more exemplary embodiments of the present disclosure. It may be seen that pore size of exemplary produced porous carbon-based material for exemplary negative electrode is larger than pore size of exemplary produced porous carbon-based material for exemplary positive electrode. On the other hand, exemplary produced porous carbon-based material for exemplary positive electrode showed a higher porosity. These results indicated that exemplary produced porous carbon material in “Example 1” for exemplary positive electrode of an exemplary lead-acid battery may be suitable for fast electrolyte as well as charge transfer result in preventing of electrode corrosion, which may be achieved due to the presence of zinc and magnesium ions and doped nitrogen and boron atoms.

### Example 4: Fabrication of Lead-Acid Battery Using Porous Carbon-Based Materials for Negative and Positive Electrodes Construction

In this example, an exemplary lead-acid battery was fabricated using exemplary porous carbon-based material in “Example 1” for exemplary positive electrode construction and exemplary produced porous carbon-based material in “Example 2” for exemplary negative electrode construction. Firstly, a positive paste was obtained by adding exemplary produced porous carbon-based material in “Example 1” to an exemplary lead-based paste with a concentration of less than 1 wt % in respect with a total weight of exemplary lead-based paste, followed by applying exemplary positive paste onto at least two exemplary grids. Following that, the at least two exemplary grids containing exemplary positive paste was dried at a temperature level of 25 °C to 70 °C and humidity level about 25% to 80% for a time duration of 25 hours to 75 hours. For fabrication of an exemplary negative electrode of exemplary lead-acid battery, first a negative paste was obtained by adding exemplary produced porous carbon-based material in “Example 2” to an exemplary lead-based paste with a concentration of less than 1 wt % in respect with a total weight of exemplary lead-based paste, followed by applying exemplary negative paste onto at least three exemplary grids. Following that, the at least three exemplary grids containing exemplary negative paste were dried at a temperature level of 25 °C to 70 °C and humidity level about 25% to 80% for a time duration of 25 hours to 75 hours.

Afterwards, the at least two exemplary dried grids containing exemplary positive paste and the at least three exemplary dried grids containing exemplary negative paste were welded together and placed into a battery casing, followed by adding acid sulfuric as an exemplary electrolyte, thereby obtaining exemplary lead-acid battery.

### Example 5: Performance of Lead-Acid Battery, Negative Electrode, and Positive Electrode

In this example, performance of exemplary produced lead-acid-battery, exemplary produced negative electrode, and exemplary produced positive electrode in “Example 4” described hereinabove was evaluated by battery performance test, cyclic voltammetry (CV), and linear sweep voltammetry (LSV), respectively.

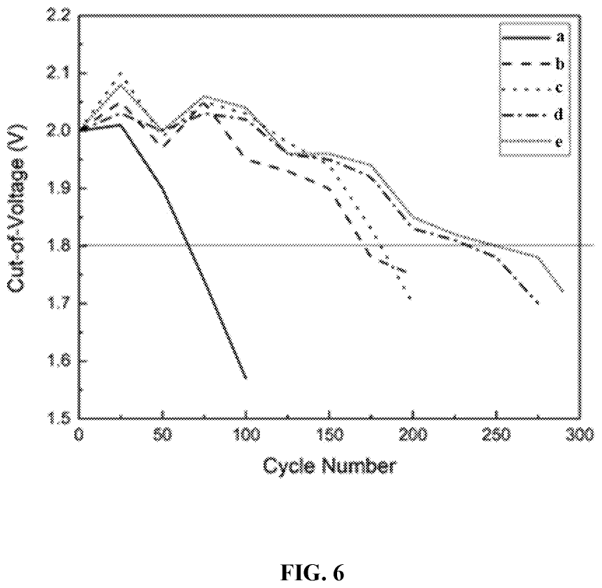

FIG. 6 illustrates a plot of cut-off voltages verses cycle number for a common lead-acid battery (graph a), an exemplary lead-acid battery including exemplary produced negative electrode (graph b), an exemplary lead-acid battery including exemplary positive electrode (graph c), an exemplary produced lead-acid battery including exemplary produced negative electrode containing 0.1 wt % of exemplary produced porous carbon-based material for exemplary negative electrode and exemplary produced positive electrode containing 0.1 wt % of an exemplary produced porous carbon-based material for exemplary positive electrode (graph d), and an exemplary produced lead-acid battery including exemplary produced negative electrode containing 0.2 wt % of exemplary produced porous carbon-based material for exemplary negative electrode and exemplary produced positive electrode containing 0.1 wt % of exemplary produced porous carbon-based material for exemplary positive electrode (graph e), consistent with one or more exemplary embodiments of the present disclosure. As shown in FIG. 6, addition of separately exemplary produced porous carbon-based materials to construct individual negative or positive electrodes does not significantly impact battery performance. However, simultaneous incorporation of exemplary produced porous carbon-based material for negative electrode and produced porous carbon-based material for positive electrode may enhance the performance of produced lead-acid battery and increase its lifespan.

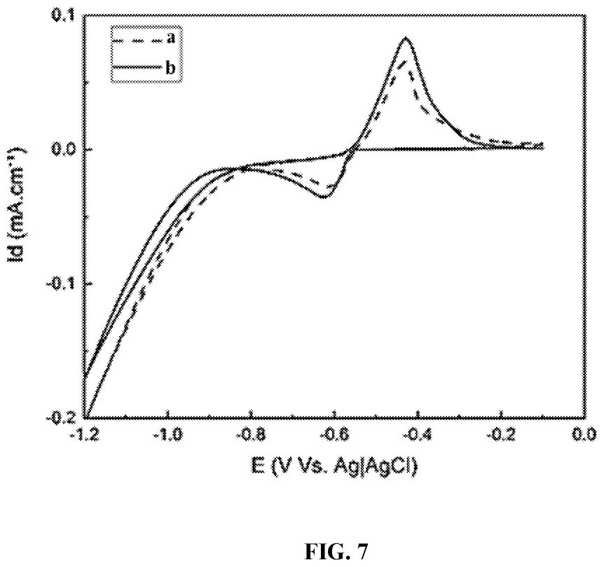

Furthermore, FIG. 7 illustrates a cyclic voltammogram of an exemplary negative electrode of an exemplary lead-acid battery without an exemplary produced porous carbon-based material (graph a) and including exemplary produced porous carbon-based material for negative electrode (graph b), consistent with one or more exemplary embodiments of the present disclosure. As may be seen, electrochemical active surface area of exemplary produced negative electrode may be increased up to 15% by adding exemplary porous carbon-based material for negative electrode construction compared to exemplary negative electrode without porous carbon-based material; thereby, resulting in a higher battery capacity as well as reduction of hydrogen gas evolution as indicated by a lower endpoint voltage at a negative potential.

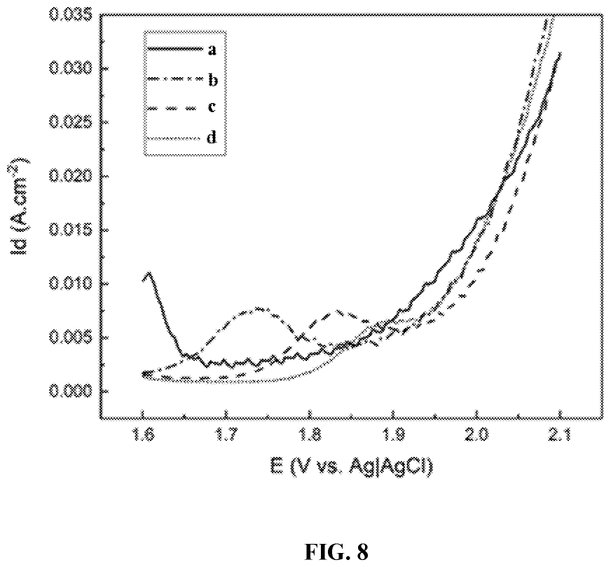

In addition, evaluation of oxygen gas release from an exemplary positive electrode was investigated by LSV analysis. FIG. 8 illustrates a current-potential (I-V) curve of an exemplary positive electrode without an exemplary produced porous carbon-based material (graph a), and an exemplary positive electrode including 0.1 wt % of exemplary porous carbon-based material for negative electrode construction (graph b), including 0.1 wt % of exemplary porous carbon-based material for positive electrode construction (graph c), and including 0.2 wt % of exemplary porous carbon-based material for positive electrode construction (graph d), consistent with one or more exemplary embodiments of the present disclosure. Exemplary results of FIG. 8 may indicate that exemplary positive electrode including exemplary porous carbon-based material for negative electrode construction may increase oxygen gas evolution. Although, exemplary positive electrodes with two different amounts of exemplary porous carbon-based material for positive electrode construction may enhance oxygen gas evolution such that exemplary concentration of 0.1 wt % shows a lower tendency for oxygen gas evolution compared to exemplary concentration of 0.2 wt %.

The exemplary above-mentioned results indicate that incorporation of 3D porous carbon-based material with different ions and doped heteroatoms for producing exemplary negative and positive electrodes of an exemplary lead-acid battery may improve battery lifespan as well as performance of each electrode.

While the foregoing has described what may be considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations. This is for purposes of streamlining the disclosure, and is not to be interpreted as reflecting an intention that the claimed implementations require more features than are expressly recited in each claim. Rather, as the following claims reflect, inventive subject matter —lies in less than all features of a single disclosed implementation. Thus, the following claims are hereby incorporated into the Detailed Description, with each claim standing on its own as a separately claimed subject matter.

While various implementations have been described, the description is intended to be exemplary, rather than limiting and it will be apparent to those of ordinary skill in the art that many more implementations and implementations are possible that are within the scope of the implementations. Although many possible combinations of features are shown in the accompanying figures and discussed in this detailed description, many other combinations of the disclosed features are possible. Any feature of any implementation may be used in combination with or substituted for any other feature or element in any other implementation unless specifically restricted. Therefore, it will be understood that any of the features shown and/or discussed in the present disclosure may be implemented together in any suitable combination. Accordingly, the implementations are not to be restricted except in light of the attached claims and their equivalents. Also, various modifications and changes may be made within the scope of the attached claims.

What is claimed is:

1. A lead-acid battery comprising:
a negative electrode comprising at least three plates, each respective plate covered by a first battery paste comprising a first porous carbon-based material with an amount in a range of 0.1 wt % to 0.5 wt % based on a total weight of the first battery paste;
a positive electrode comprising at least two plates, each respective plate covered by a second battery paste comprising a second porous carbon-based material with an amount in a range of 0.1 wt % to 0.5 wt % based on a total weight of the second battery paste; and
an electrolyte in physical contact with the negative electrode and the positive electrode.

2. The lead-acid battery of claim 1, wherein each of the first porous carbon-based material and the second porous carbon-based material comprises:
a plurality of porous carbon-based sheets;
a plurality of at least one metal ion distributed between the plurality of porous carbon-based sheets, the plurality of porous carbon-based sheets being cross-linked together via the plurality of the at least one metal ion; and
a plurality of at least one heteroatom, the plurality of porous carbon-based sheets being doped with the plurality of the at least one heteroatom.

3. The lead-acid battery of claim 2, wherein the plurality of porous carbon-based sheets comprises at least one of graphene, graphene aerogel, graphene oxide, reduced graphene oxide, three-dimensional graphene, graphene oxide aerogel, aerographene, and combinations thereof.

4. The lead-acid battery of claim 2, wherein:
the plurality of porous carbon-based sheets of the first porous carbon-based material comprises an average pore size within a range of 25 nm to 50 nm; and
the plurality of porous carbon-based sheets of the second porous carbon-based material comprises an average pore size within a range of 5 nm to 20 nm.

5. The lead-acid battery of claim 2, wherein the at least one metal ion comprises at least one of a transition metal ion, an alkaline earth metal ion, and combinations thereof.

6. The lead-acid battery of claim 5, wherein an amount of the plurality of the at least one metal ion is in a range of 0.1 wt % to 5 wt % based on a total weight of each of the first porous carbon-based material and the second porous carbon-based material.

7. The lead-acid battery of claim 5, wherein the at least one metal ion of the first porous carbon-based material comprises at least one of zinc, copper, nickel, cobalt, and combinations thereof.

8. The lead-acid battery of claim 7, wherein an amount of copper is in a range of 0.2 wt % to 1.5 wt % based on a total weight of the first porous carbon-based material.

9. The lead-acid battery of claim 7, wherein an amount of zinc is in a range of 0.3 wt % to 1.6 wt % based on a total weight of the first porous carbon-based material.

10. The lead-acid battery of claim 5, wherein the at least one metal ion of the second porous carbon-based material comprises at least one of zinc ion, magnesium ion, calcium ion, and combinations thereof.

11. The lead-acid battery of claim 10, wherein an amount of magnesium is in a range of 0.2 wt % to 1.0 wt % based on a total weight of the second porous carbon-based material.

12. The lead-acid battery of claim 10, wherein an amount of zinc is in a range of 0.3 wt % to 1.6 wt % based on a total weight of the second porous carbon-based material.

13. The lead-acid battery of claim 2, wherein an amount of the plurality of the at least one heteroatom is in a range of 0.1 wt % to 2.0 wt % based on a total weight of each of the first porous carbon-based material and the second porous carbon-based material.

14. The lead-acid battery of claim 2, wherein the plurality of the at least one heteroatom of the first porous carbon-based material comprises at least one of nitrogen, sulfur, and combinations thereof.

15. The lead-acid battery of claim 14, wherein an amount of nitrogen is in a range of 0.5 wt % to 2 wt % based on a total weight of the first porous carbon-based material.

16. The lead-acid battery of claim 14, wherein an amount of sulfur is in a range of 0.1 wt % to 1 wt % based on a total weight of the first porous carbon-based material.

17. The lead-acid battery of claim 2, wherein the plurality of the at least one heteroatom of the second porous carbon-based material comprises at least one of nitrogen, boron, phosphorus, sulfur, and combinations thereof.

18. The lead-acid battery of claim 17, wherein the plurality of the at least one heteroatom of the second porous carbon-based material comprises a combination of at least two heteroatoms with a weight ratio of a first heteroatom to a second heteroatom in a range of 1:0 to 0:1.

19. The lead-acid battery of claim 17, wherein an amount of nitrogen is in a range of 0.1 wt % to 1.5 wt % based on a total weight of the second porous carbon-based material.

20. The lead-acid battery of claim 17, wherein an amount of each heteroatom of boron, phosphorus, or sulfur is in a range of 0.1 wt % to 1 wt % based on a total weight of the second porous carbon-based material.
